(19) United States
(12) Patent Application Publication
(10) Pub. No.: US 2018/0101413 A1
(43) Pub. Date: Apr. 12, 2018

(54) CONTROL DEVICE AND CONTROL METHOD

(71) Applicant: FUJITSU LIMITED, Kawasaki-shi (JP)

(72) Inventor: Naotoshi WATANABE, Yokohama (JP)

(73) Assignee: FUJITSU LIMITED, Kawasaki-shi (JP)

(21) Appl. No.: 15/702,931

(22) Filed: Sep. 13, 2017

(30) Foreign Application Priority Data
Oct. 11, 2016 (JP) 2016-199862

(51) Int. Cl. G06F 9/50

(52) U.S. Cl. CPC G06F 9/5077; G06F 2209/5011

(57) ABSTRACT

A control device includes a memory and a processor coupled to the memory. The processor is configured to determine whether a correlation is present between increase or decrease of a first amount of first virtual machines for performing a first function and increase or decrease of a second amount of second virtual machines for performing a second function. The processor is configured to determine a capacity of spare virtual machines in response to increase or decrease of the first amount upon determining that the correlation is present. The spare virtual machines are prepared for performing the second function. The capacity is a maximum amount.

### CROSS-REFERENCE TO RELATED APPLICATION

This application is based upon and claims the benefit of priority of the prior Japanese Patent Application No. 2016-199862, filed on Oct. 11, 2016, the entire contents of which are incorporated herein by reference.

### FIELD

The embodiments discussed herein are related to a control device and a control method.

### BACKGROUND

A cloud system has recently been suggested as one of usage forms of computer resources. The cloud system is a system in which a user uses computer resources via a network. In many cases, the cloud system is implemented as a virtual system in which a plurality of virtual computers (virtual machines) are arranged so that resources may be flexibly allocated to a plurality of users.

As a technology for providing a virtual system, there has been suggested a network function virtualization (NFV) defined by the European telecommunications standards institute (ETSI) which is a standardization organization. The NFV is a technology for preparing a software package of virtualized network nodes such as routers and executing the software package in a virtual machine within a general-purpose server.

As a technique using the NFV, there is known a technique related to an operation management device that performs a scaling control of a network node depending on the load of the virtualized network node. The scaling refers to a technique of controlling an increase or decrease (scale out/scale in) of the number of virtual machines.

In a system of managing virtual machines that are environments where applications are executed, there is known a technique of preparing a spare virtual machine group in which applications are installed in advance in order to reduce an influence caused by failure of the virtual machines.

Related technologies are disclosed in, for example, Japanese Laid-Open Patent Publication No. 2015-149578 and Japanese Laid-Open Patent Publication No. 2015-191246.

### SUMMARY

According to an aspect of the present invention, provided is a control device including a memory and a processor coupled to the memory. The processor is configured to determine whether a correlation is present between increase or decrease of a first amount of first virtual machines for performing a first function and increase or decrease of a second amount of second virtual machines for performing a second function. The processor is configured to determine a capacity of spare virtual machines in response to increase or decrease of the first amount upon determining that the correlation is present. The spare virtual machines are prepared for performing the second function. The capacity is a maximum amount.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of a control device according to a first embodiment;

FIG. 2 is a diagram illustrating an exemplary configuration of an information processing system according to a second embodiment;

FIG. 3 is a diagram illustrating an exemplary hardware configuration of a virtual resource management server according to the second embodiment;

FIG. 4 is a diagram illustrating an exemplary arrangement of resources in a cloud system according to the second embodiment;

FIG. 5 is a diagram illustrating an example of service connection information according to the second embodiment;

FIG. 6 is a diagram illustrating an example of application management information according to the second embodiment;

FIG. 7 is a diagram illustrating an exemplary processing sequence in the information processing system according to the second embodiment;

FIG. 8 is a flowchart illustrating a flow of a resource control process according to the second embodiment;

FIG. 9 is a diagram illustrating an example of operation mode management information according to the second embodiment;

FIG. 10 is a flowchart illustrating a flow of a correlation determination process according to the second embodiment;

FIG. 11 is a diagram illustrating an example of an event log according to the second embodiment;

FIG. 12 is a diagram illustrating an example of correlation observation information according to the second embodiment;

FIG. 13 is a diagram illustrating an example of correlation determination information according to the second embodiment;

FIG. 14 is a flowchart illustrating a flow of a correlation control process according to the second embodiment;

FIG. 15 is a diagram illustrating an example of resource pool state information according to the second embodiment;

FIG. 16 is a diagram illustrating an example of resource pool control information according to the second embodiment;

FIG. 17 is a flowchart illustrating a flow of an empty-resource-pool process according to the second embodiment; and

FIG. 18A is a diagram illustrating a control of a resource pool before and after execution of scale-out according to the second embodiment, and FIG. 18B is a diagram illustrating a control of the resource pool before and after execution of scale-in according to the second embodiment.

### DESCRIPTION OF EMBODIMENTS

In an area (hereinafter, referred to as a resource pool) that holds a group of spare virtual machines in which applications are installed in advance, it is required to secure a capacity allowing an amount of spare virtual machines to be held so as to cope with even the case where the demand of services provided by applications is rapidly increased or decreased. Thus, it is necessary to set the amount of virtual machines in a resource pool such that virtual machines are not exhausted in response to a load fluctuation of applications due to the increase or decrease in the demand of services.

When the amount of spare virtual machines in a resource pool is set to the amount corresponding to the maximum demand of services, it is possible to avoid a situation in which the virtual machines are exhausted, but the cost of management or operation is increased in order to continuously secure extra virtual machines.

Thus, in a virtualization system, there is an object in that an amount of spare virtual machines is suppressed to the extent that exhaustion of virtual machines is avoided and services for customers are not impaired.

Hereinafter, embodiments will be described in detail with reference to drawings.

### First Embodiment

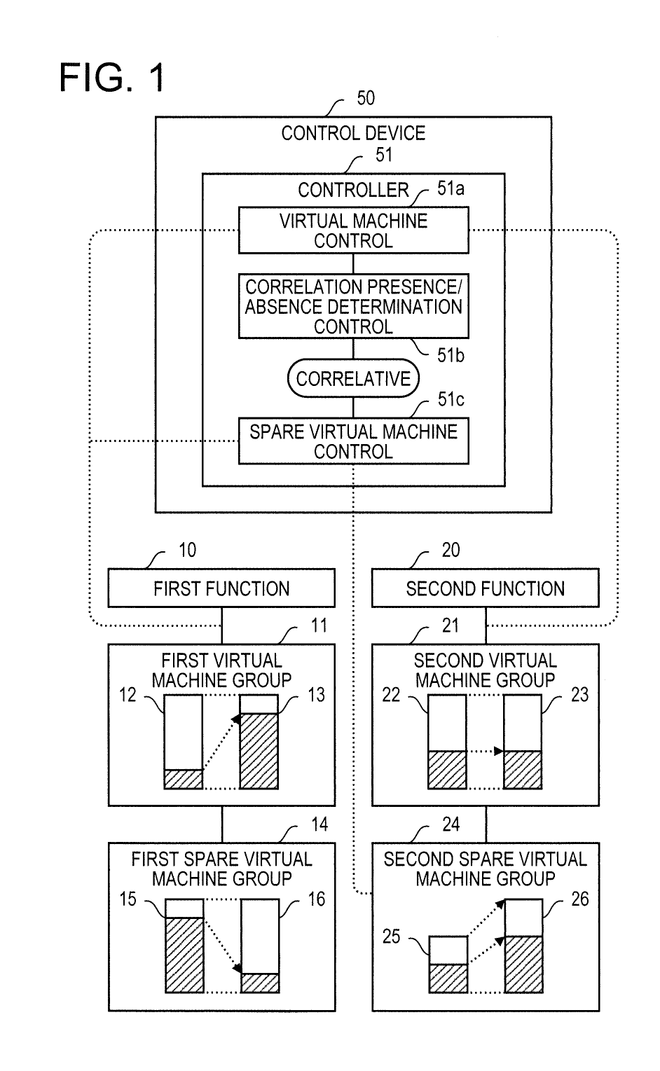

First, a control device according to the first embodiment will be described with reference to FIG. 1. FIG. 1 is a diagram illustrating an exemplary functional configuration of the control device according to the first embodiment.

A control device 50 includes a controller 51. The control device 50 is an information processing device, e.g., a computer, that controls a virtual machine for performing a predetermined function, or a spare virtual machine prepared for performing the predetermined function.

A virtual machine includes various computer resources such as a program executed by the virtual machine, a program waiting in the virtual machine, a processor and a memory allocated to the virtual machine, and the like.

The predetermined function is a function implemented by executing various programs, and is a function implemented when the control device 50 causes a computer to execute a program. A first function 10 is a function implemented when a first program is executed by a virtual machine included in, for example, a first virtual machine group 11. A second function 20 is a function implemented when a second program is executed by a virtual machine included in, for example, a second virtual machine group 21. The first virtual machine group 11 includes virtual machines that perform the first function 10. That is, the first virtual machine group 11 includes virtual machines that execute the first program. The second virtual machine group 21 includes virtual machines that perform the second function 20. That is, the second virtual machine group 21 includes virtual machines that execute the second program. The first program and the second program may have the same function or different functions.

The controller 51 performs a virtual machine control 51a, a correlation presence/absence determination control 51b, and a spare virtual machine control 51c. The virtual machine control 51a is a control to increase or decrease virtual machines. Specifically, the virtual machine control 51a is a control to increase virtual machines by allocating spare virtual machines prepared for performing a predetermined function to virtual machines for performing the predetermined function. The virtual machine control 51a also includes a control to decrease virtual machines by releasing virtual machines for performing the predetermined function, and setting the released machines to spare virtual machines prepared for performing the predetermined function.

The virtual machine control 51a is, for example, a scale-in or a scale-out control. In the virtual machine control 51a, when the load of virtual machines for performing a predetermined function is increased, the scale-out is executed in which spare virtual machines are allocated to the virtual machines to increase the virtual machines. In the virtual machine control 51a, when the load of virtual machines for performing a predetermined function is decreased, the scale-in is executed in which the virtual machines allocated to the predetermined function are released and returned to the spare virtual machines so as to decrease the virtual machines.

The correlation presence/absence determination control 51b is a control to determine whether there is a correlation between a predetermined function (e.g., the first function 10) for which a control to increase or decrease virtual machines has been performed in the virtual machine control 51a, and another predetermined function (e.g., the second function 20).

In the correlation presence/absence determination control 51b, it is determined whether there is a correlation between an increase/decrease in the first virtual machine group 11 for performing the first function 10, and an increase/decrease in the second virtual machine group 21 for performing the second function 20.

Here, determination on presence/absence of the correlation will be described. For example, when it is recognized that scale-in is executed on the second virtual machine group 21 for performing the second function 20 in association with execution of scale-in on the first virtual machine group 11 for performing the first function 10, it may be determined that there is a correlation between the first function 10 and the second function 20. When it is recognized that scale-out is executed on the second virtual machine group 21 for performing the second function 20 in association with execution of scale-out on the first virtual machine group 11 for performing the first function 10, it may be determined that there is a correlation between the first function 10 and the second function 20. In the correlation presence/absence determination control 51b, the second function 20 having a correlation with the first function 10 for which virtual machines are increased or decreased is determined as a correlated function.

The spare virtual machine control 51c is a control to change a capacity of spare virtual machines prepared to be allocated to the correlated function when it is determined that there is a correlation in the correlation presence/absence determination control 51b. For example, a maximum capacity of spare virtual machines prepared for performing the correlated function may be determined in the spare virtual machine control 51c. In the spare virtual machine control 51c, not only the maximum capacity of spare virtual machines prepared for performing the correlated function, but also a minimum capacity or the like of spare virtual machines may be determined.

In the spare virtual machine control 51c, upon the second function 20 being determined as a correlated function, control on the capacity of a second spare virtual machine group 24 prepared for performing the second function 20 is performed based on an increase/decrease of the virtual machines for performing the first function 10. A first spare virtual machine group 14 includes spare virtual machines prepared for performing the first function 10. The first spare virtual machine group 14 may also include, as spare virtual machines, virtual machines that are unallocated from the first virtual machine group 11. The first spare virtual machine group 14 is a resource pool corresponding to, for example, the first function 10. The second spare virtual machine group 24 includes spare virtual machines prepared for performing the second function 20. The second spare virtual machine group 24 may also include, as spare virtual machines, virtual machines that are unallocated from the second virtual machine group 21. The second spare virtual machine group 24 is a resource pool corresponding to, for example, the second function 20.

For example, descriptions will be made on the case where scale-out is executed on virtual machines for performing the first function 10. In the spare virtual machine control 51c, spare virtual machines included in the first spare virtual machine group 14 are allocated to the first virtual machine group 11 and the number of virtual machines in the first virtual machine group 11 are increased (12, 13), and then, the number of spare virtual machines in the first spare virtual machine group 14 is decreased (15, 16). In the spare virtual machine control 51c, as the number of virtual machines in the first virtual machine group 11 are increased (12, 13), the capacity for holding spare virtual machines in the second spare virtual machine group 24 is increased (25, 26). In the spare virtual machine control 51c, even when the increase/decrease control of virtual machines in the second virtual machine group 21 is not performed and there is no increase/decrease in the second virtual machine group 21 (22, 23), the capacity of the second spare virtual machine group 24 (25, 26) may be increased.

As described above, when executing scale-in or scale-out on the first virtual machine group 11 including virtual machines for performing the first function 10, the controller 51 controls the capacity of the second spare virtual machine group 24 corresponding to the second function 20 having a correlation.

Even when scale-in or scale-out is not executed on the second virtual machine group 21, the controller 51 may control the capacity of the second spare virtual machine group 24. That is, the controller 51 may increase the capacity of the second spare virtual machine group 24 before the scale-out is executed on the second virtual machine group 21, thereby reducing the exhaustion of spare virtual machines in relation to the second function 20. The controller 51 may decrease the capacity of the second spare virtual machine group 24 before the scale-in is executed on the second virtual machine group 21, thereby reducing excessive allocation of spare virtual machines in relation to the second function 20.

As described above, the control device 50 may control the second spare virtual machine group 24 in response to scaling of the first virtual machine group 11 including virtual machines for performing the first function 10. Thus, the control device 50 may avoid the exhaustion of spare virtual machines allocated to the second function 20 while attempting to reduce the number of spare virtual machines.

### Second Embodiment

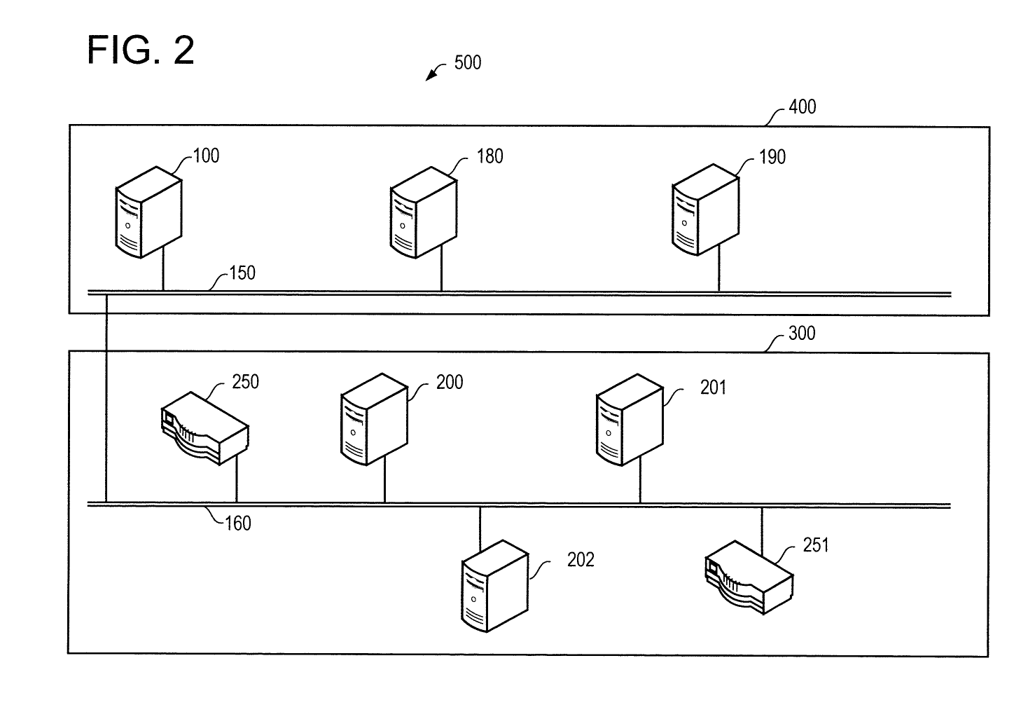

Hereinafter, an information processing system according to a second embodiment will be described with reference to FIG. 2. FIG. 2 is a diagram illustrating an exemplary configuration of the information processing system according to the second embodiment.

An information processing system 500 includes a management system 400 and a cloud system 300. The management system 400 and the cloud system 300 are coupled to each other via a network.

The management system 400 includes a virtual resource management server 100, a virtual infrastructure management server 180, and an application management server 190. The virtual infrastructure management server 180 and the application management server 190 are coupled to the virtual resource management server 100 via a network 150. The management system 400 performs a management and a control of physical resources of the cloud system 300 and resources required for virtual machines. The management system 400 has functions such as, for example, an NFV management and orchestration (MANO), an operation support system/business support system (OSS/BSS), and an NFV infrastructure (NFVI) defined by ETSI. Various programs such as applications executed by the information processing system 500 may be provided by a virtual network function (VNF).

The virtual resource management server 100 is a computer that manages and controls virtual resources. For example, the virtual resource management server 100 manages and executes scale-in and scale-out, and manages and controls a resource pool. The virtual resource management server 100 may execute a program that implements a control method of various resources.

The virtual infrastructure management server 180 is a computer that manages and controls resources as a basis for implementing virtual machines.

The application management server 190 is a computer that manages and controls applications that are provided to a user by the cloud system 300.

The cloud system 300 is a system provided to a user such as a company. The cloud system 300 includes routers 250 and 251 and general-purpose servers 200, 201, and 202. The general-purpose servers 200, 201, and 202 are coupled to the routers 250 and 251 via a network 160.

The general-purpose servers 200, 201, and 202 are computers that may operate a plurality of virtual machines. An application that implements the service to be provided to a user is executed by a virtual machine. The routers 250 and 251 are communication devices that relay data.

The information processing system 500 may include a plurality of cloud systems 300. The management system 400 may manage the plurality of cloud systems 300. The above-described configuration is exemplary only, and the cloud system 300 may include one or more general-purpose servers 200 and one or more routers 250.

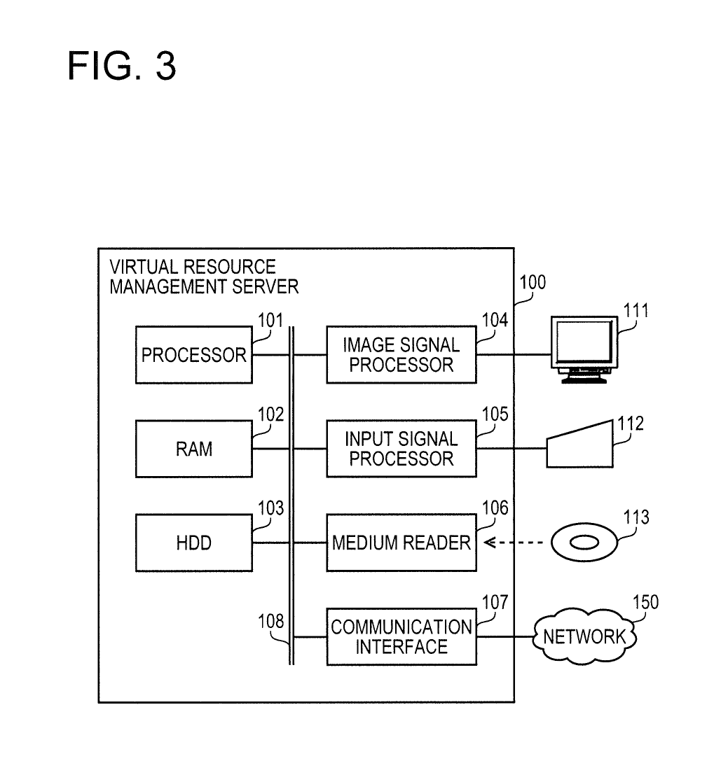

Next, descriptions will be made on a hardware configuration of the virtual resource management server 100 according to the second embodiment with reference to FIG. 3. FIG. 3 is a diagram illustrating an exemplary hardware configuration of the virtual resource management server 100 according to the second embodiment.

The virtual resource management server 100 includes a processor 101, a random access memory (RAM) 102, and a plurality of peripheral devices. The entire apparatus of the virtual resource management server 100 is controlled by the processor 101. The processor 101 is coupled to the RAM 102 and the plurality of peripheral devices via a bus 108. The processor 101 may be a multi-processor. The processor 101 is, for example, a central processing unit (CPU), a micro processing unit (MPU), a digital signal processor (DSP), an application specific integrated circuit (ASIC), or a programmable logic device (PLD). The processor 101 may include a combination of two or more elements among the CPU, the MPU, the DSP, the ASIC, and the PLD. The processor 101 is an example of the controller 51 in the first embodiment.

The RAM 102 is used as a main storage device of the virtual resource management server 100. The RAM 102 is a volatile memory that temporarily stores therein a program executed by the processor 101 or data used for calculation by the processor 101. The virtual resource management server 100 may include any type of memory other than the RAM. The virtual resource management server 100 may include a plurality of memories.

The peripheral devices coupled to the bus 108 may include a hard disk drive (HDD) 103, an image signal processor 104, an input signal processor 105, a medium reader 106, and a communication interface 107.

The HDD 103 is a non-volatile storage device that stores therein software programs such as an operating system (OS), middleware, and application software, and data. The virtual resource management server 100 may include another type of storage device such as a flash memory or a solid state drive (SSD). The virtual resource management server 100 may include a plurality of non-volatile storage devices.

The image signal processor 104 outputs an image to a display 111 coupled to the virtual resource management server 100 in accordance with an instruction from the processor 101. As the display 111, a cathode ray tube (CRT) display, a liquid crystal display (LCD), a plasma display panel (PDP), an organic electro-luminescence (OEL) display, or the like may be used.

The input signal processor 105 acquires an input signal from an input device 112 coupled to the virtual resource management server 100, and outputs the signal to the processor 101. As the input device 112, a pointing device such as a mouse, a touch panel, a touch pad, a track ball, or the like, a keyboard, a remote controller, a button switch, or the like may be used. A plurality of types of input devices may be coupled to the virtual resource management server 100.

The medium reader 106 is a reading device that reads programs or data recorded in a recording medium 113. As the recording medium 113, for example, a magnetic disk such as a flexible disk (FD) or an HDD, an optical disk such as a compact disc (CD) or a digital versatile disc (DVD), a magneto-optical disk (MO), a semiconductor memory, or the like may be used. The medium reader 106 stores, for example, programs or data read from the recording medium 113 in the RAM 102 or the HDD 103.

The communication interface 107 is an interface that is coupled to the network 150, and communicates with other computers via the network 150. The communication interface 107 may be a wired communication interface coupled to a communication device by a cable, or a wireless communication interface coupled to a base station via a wireless link.

The virtual resource management server 100 does not necessarily include the medium reader 106. The virtual resource management server 100 does not necessarily include the image signal processor 104 and the input signal processor 105 when the virtual resource management server 100 is controllable from a terminal device operated by a user. The display 111 or the input device 112 may be integrally formed with a housing of the virtual resource management server 100. The virtual infrastructure management server 180, the application management server 190, and the general-purpose servers 200, 201, and 202 may also be implemented using similar hardware as the virtual resource management server 100.

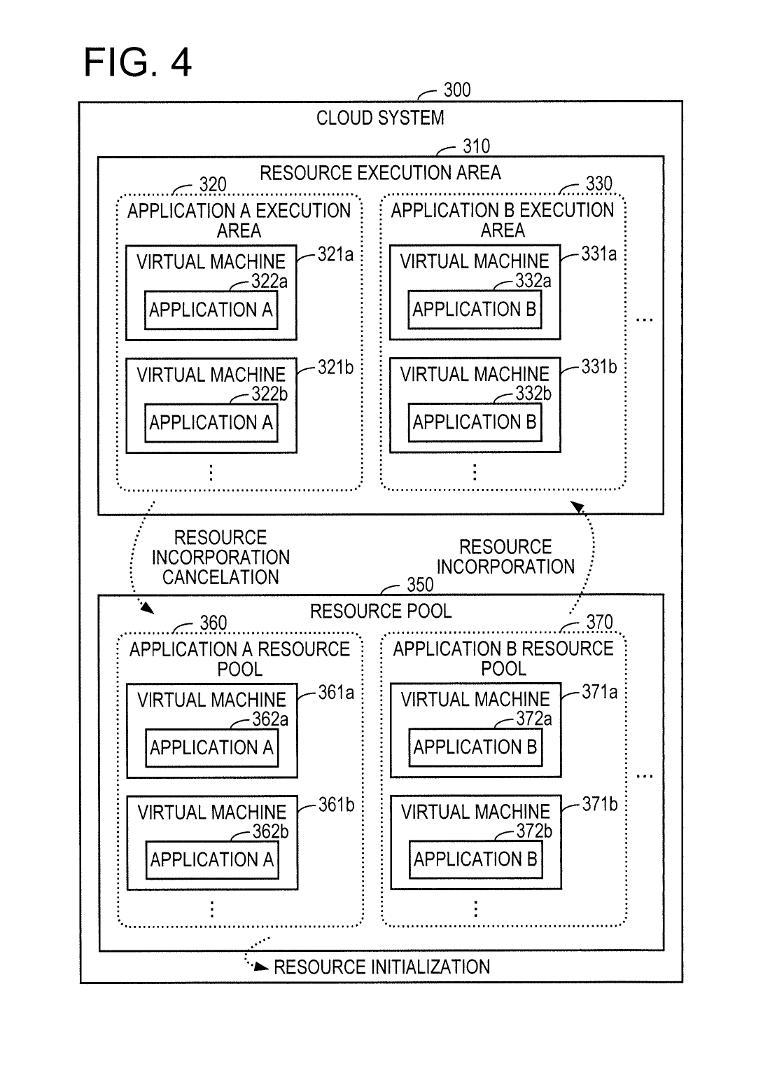

Next, descriptions will be made on an arrangement of resources in the cloud system 300 according to the second embodiment with reference to FIG. 4. FIG. 4 is a diagram illustrating an exemplary arrangement of resources in the cloud system 300 according to the second embodiment.

The cloud system 300 includes a resource execution area 310 and a resource pool 350. The resource execution area 310 is a virtual area in which applications for providing services are executed. The resource pool 350 is a virtual area in which resources are prepared. The resources include hardware resources such as CPUs, memories, and HDDs, and software resources such as virtual machines and applications. The applications include various programs such as a program for providing functions of a web server, or a program for providing functions of a database. The resource execution area 310 and the resource pool 350 are provided by any of the general-purpose servers 200, 201, and 202. In the following description, virtual machines and applications are illustrated as the resources, and illustration of hypervisors or hardware resources for implementing the virtual machines is omitted.

Resources included in the cloud system 300 are controlled by the virtual resource management server 100. When the load of an application executed in the resource execution area 310 increases to a predetermined value or more, the virtual resource management server 100 increases resources to be provided by incorporating resources prepared in the resource pool 350 into the resource execution area 310 When the load of the application executed in the resource execution area 310 decreases to a predetermined value or less, the virtual resource management server 100 decreases resources to be provided by canceling the incorporation of resources to be executed in the resource execution area 310. When resources are present more than necessary in the resource pool 350, the virtual resource management server 100 initializes the resources so that the resources are not associated with a specific application and may be used for other services.

The resource execution area 310 includes an application A execution area 320 and an application B execution area 330. The application A execution area 320 is a virtual area including a virtual machine 321a (321b) which executes an application A 322a (322b). The application B execution area 330 is a virtual area including a virtual machine 331a (331b) which executes an application B 332a (332b).

The resource pool 350 includes an application A resource pool 360 and an application B resource pool 370. The application A resource pool 360 is a virtual area including a virtual machine 361a (361b) in which an application A 362a (362b) is caused to stand by. The application B resource pool 370 is a virtual area including a virtual machine 371a (371b) in which an application B 372a (372b) is caused to stand by.

The above-described arrangement of resources is exemplary only, and one or more resources only have to be in an execution state in the resource execution area 310, and one or more resources only have to be in a preparation state in the resource pool 350.

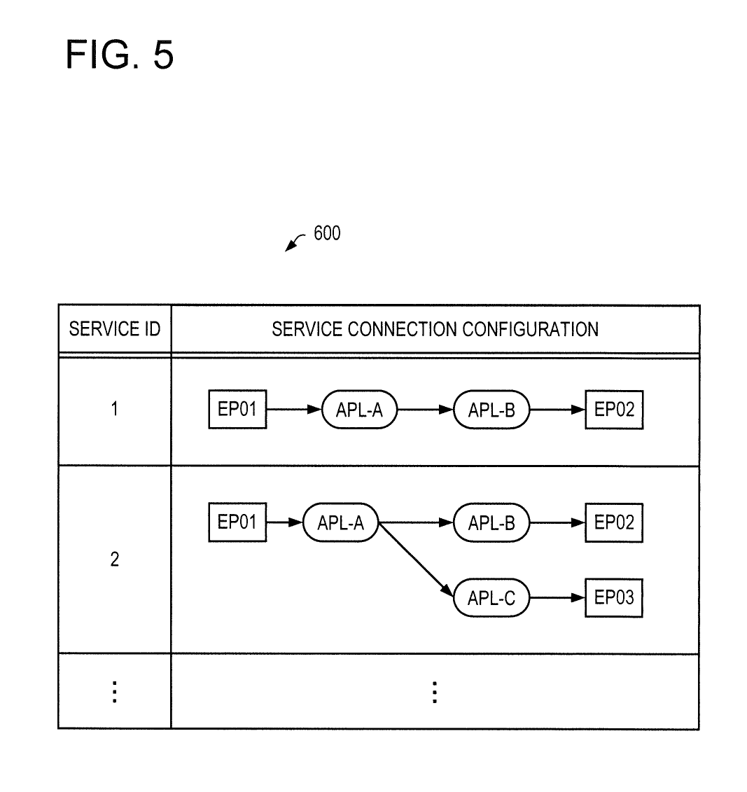

Next, descriptions will be made on service connection information according to the second embodiment with reference to FIG. 5. FIG. 5 is a diagram illustrating an example of the service connection information according to the second embodiment.

Service connection information 600 indicates a flow of data in the services of applications provided by the cloud system 300.

Each record of the service connection information 600 includes items of a service identifier (ID) and a service connection configuration. The service ID is identification information used for identifying a service. The service connection configuration indicates the flow of data using IDs. A user may use a plurality of services identified by service IDs in parallel.

The start point and the terminal point of a route through which data flows are indicated by end point IDs (EP01, EP02, and EP03) for identifying end points. The start point or the terminal point of a route through which data flows corresponds to the router 250 or 251.

The relay points through which data flows are indicated by application IDs (APL-A, APL-B, and APL-C) identifying applications for providing services. The relay points through which data flows correspond to applications executed by any one of the general-purpose servers 200, 201, and 202 or part thereof. It is assumed that the application ID of the application A is APL-A, the application ID of the application B is APL-B, and the application ID of the application C is APL-C.

In the example of FIG. 5, a record with service ID “1” indicates that data flows in the order from EP01 as a start point, to EP02 as a terminal point through APL-A and APL-B. A record with service ID “2” indicates that data flows from EP01 as a start point, flows through APL-A, then diverges to EP02 and EP03 as terminal points through APL-B and APL-C, respectively.

The flow of data is defined by a transmission source address and a destination address, a port number, a routing table defined by the routers 250 and 251, or the like in accordance with a communication protocol, but details thereof will be omitted.

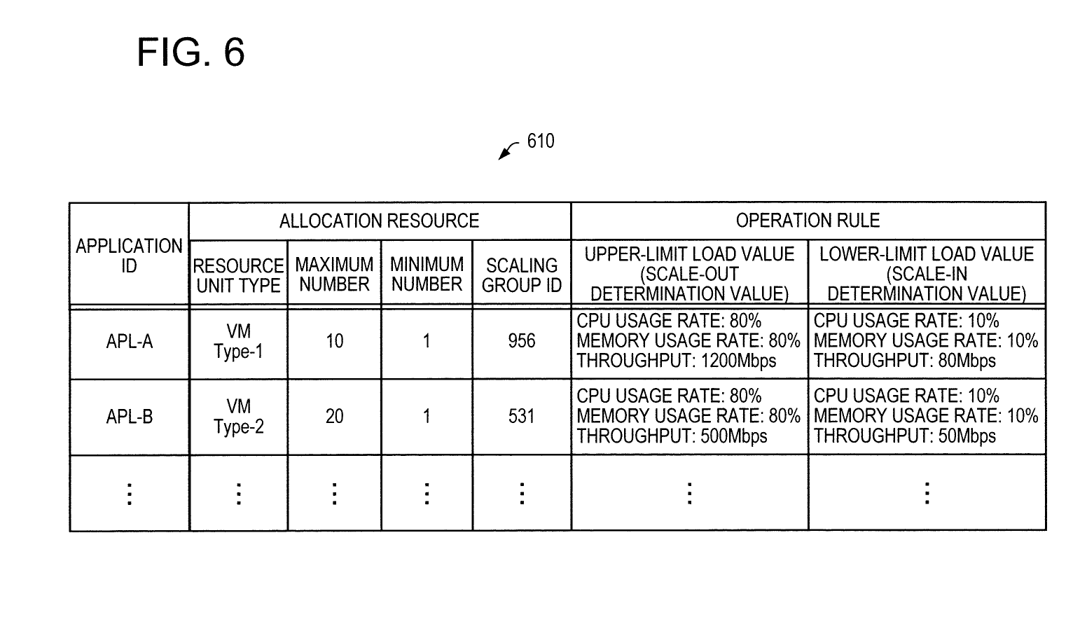

Next, application management information according to the second embodiment will be descried with reference to FIG. 6. FIG. 6 is a diagram illustrating an example of the application management information according to the second embodiment.

Application management information 610 is information in which an allocation resource and an operation rule are set for each application. The application management information 610 is stored in a storage unit such as the HDD 103 of the virtual resource management server 100. The application management information 610 is set by an operator of the management system 400.

Each record of the application management information 610 includes items of an application ID, allocation resource, and operation rule. The allocation resource is information in which resources to be allocated to an application indicated by the application ID are defined. The allocation resource includes a resource unit type, a maximum number, a minimum number, and a scaling group ID. The resource unit type indicates the type of the virtual machine which executes the application indicated by the application ID. The maximum number indicates a maximum number of virtual machines indicated by the resource unit type and implemented by the resources. The minimum number indicates a minimum number of virtual machines indicated by the resource unit type and implemented by the resources. The scaling group ID is information used for identifying a unit for controlling the scaling of the virtual machines corresponding to the application ID.

The operation rule is information used for operating the scaling by the virtual resource management server 100. The operation rule includes an upper-limit load value and a lower-limit load value. The upper-limit load value is a value used when the virtual resource management server 100 determines whether to execute scale-out on an application. When the load of the application indicated by the application ID exceeds the upper-limit load value, the virtual resource management server 100 issues an instruction to execute the scale-out.

The lower-limit load value is a value used when the virtual resource management server 100 determines whether to execute scale-in on an application. When the load of the application indicated by the application ID is lower than the lower-limit load value, the virtual resource management server 100 issues an instruction to execute the scale-in.

The upper-limit load value and the lower-limit load value include a CPU usage rate, a memory usage rate, and a throughput. Values of the CPU usage rate, the memory usage rate, and the throughput are values for an allocation resource unit, that is, values of a usage rate of a CPU allocated to virtual machines, a usage rate of a memory allocated to the virtual machines, and a throughput of an application executed by the virtual machines. The CPU usage rate and the like are merely examples of indicators for measuring the load, and values other than those may also be employed.

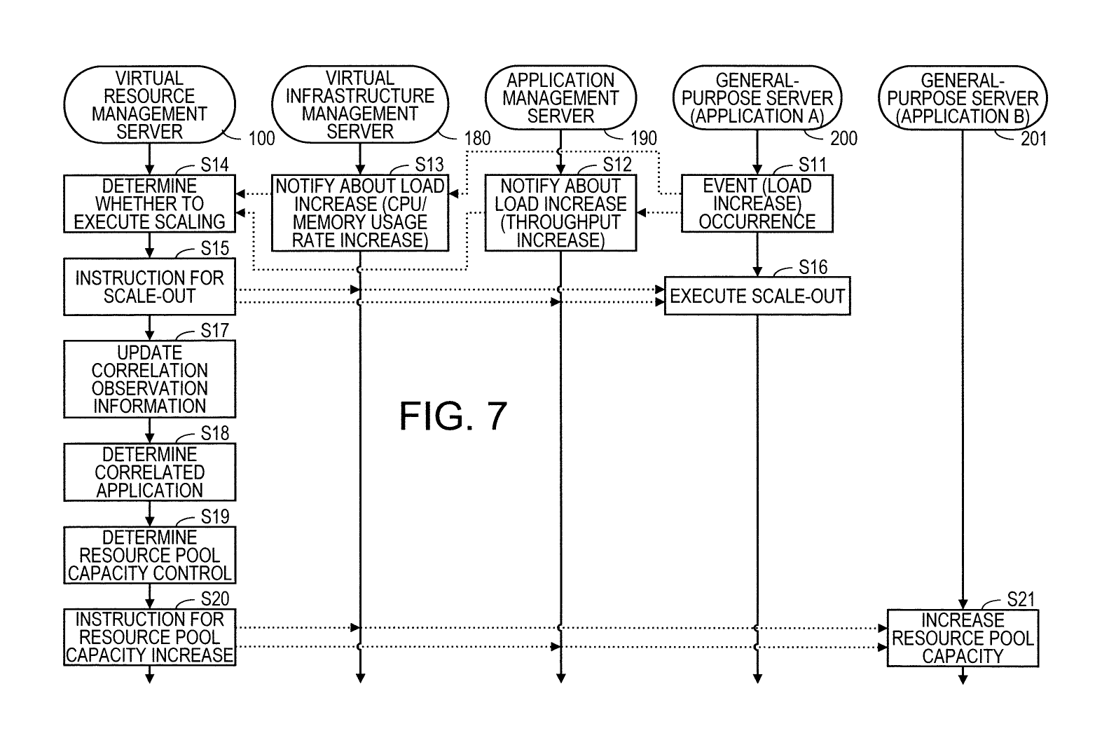

Next, a processing sequence in the information processing system according to the second embodiment will be described with reference to FIG. 7. FIG. 7 is a diagram illustrating an example of the processing sequence in the information processing system according to the second embodiment.

The processing of each of the virtual resource management server 100, the virtual infrastructure management server 180, and the application management server 190 is performed by a controller (processor 101) included in each computer. It is assumed that the controller (processor 101) of the general-purpose server 200 executes an application A, and a controller (processor 101) of the general-purpose server 201 executes an application B.

(S11) In the general-purpose server 200, an event of a load increase occurs in the application A.

(S12) The application management server 190, which manages applications executed by the cloud system 300, detects the load increase (a throughput increase) in the application A, and notifies the virtual resource management server 100 of the load increase.

(S13) The virtual infrastructure management server 180, which manages an infrastructure system providing a virtual system implemented by the cloud system 300, detects the load increase (a usage rate increase of a CPU or a memory) in the application A, and notifies the virtual resource management server 100 of the load increase.

(S14) The virtual resource management server 100 receives information on the load increase from the application management server 190 or the virtual infrastructure management server 180, and determines whether to execute scaling for the application A in which the event of the load increase has occurred.

Here, the virtual resource management server 100 determines that the execution of the scale-out of the application A is to be executed as the load of the application A exceeds an upper-limit load value included in the application management information 610.

(S15) The virtual resource management server 100 instructs the virtual infrastructure management server 180 and the application management server 190 to execute the scale-out of the application A.

The virtual infrastructure management server 180 performs a control to allocate resources such as a CPU or a memory to a virtual machine implemented by the general-purpose server 200. The application management server 190 controls the general-purpose server 200 to implement the virtual machine and execute the applications A to be added.

(S16) The general-purpose server 200 executes the scale-out under the control of the virtual infrastructure management server 180 and the application management server 190. That is, the general-purpose server 200 increases the amount of virtual machines for executing the application A in the application A execution area 320. The increasing the amount of the virtual machines includes increasing the number of the virtual machines.

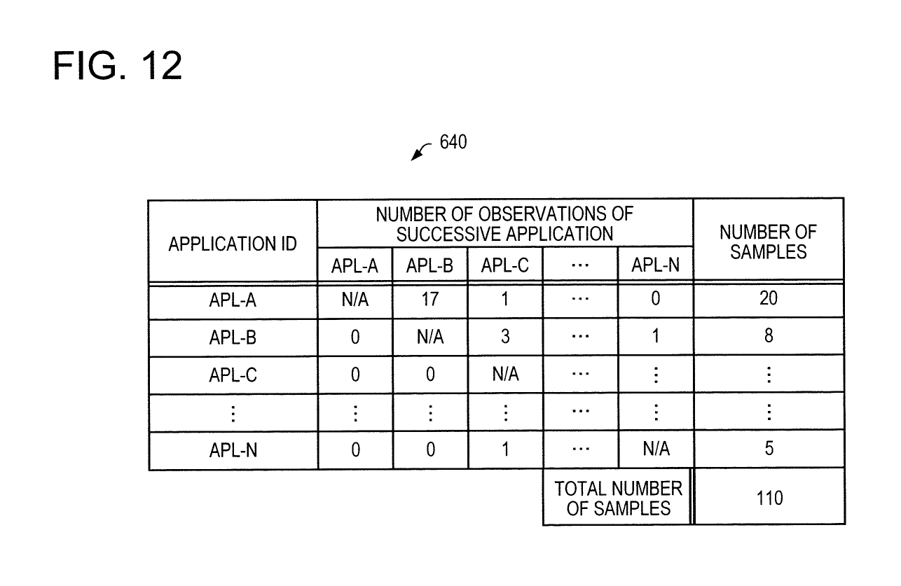

(S17) The virtual resource management server 100 updates correlation observation information in response to the execution of the scale-out. The correlation observation information is used for determining a correlated application. The correlation observation information will be described later with reference to FIG. 12.

(S18) The virtual resource management server 100 determines an application correlated with the application A in which the event has occurred, using the correlation observation information. In the following description, an application in which an event has occurred is referred to as an event-occurred application, and an application correlated with the event-occurred application is referred to as a correlated application.

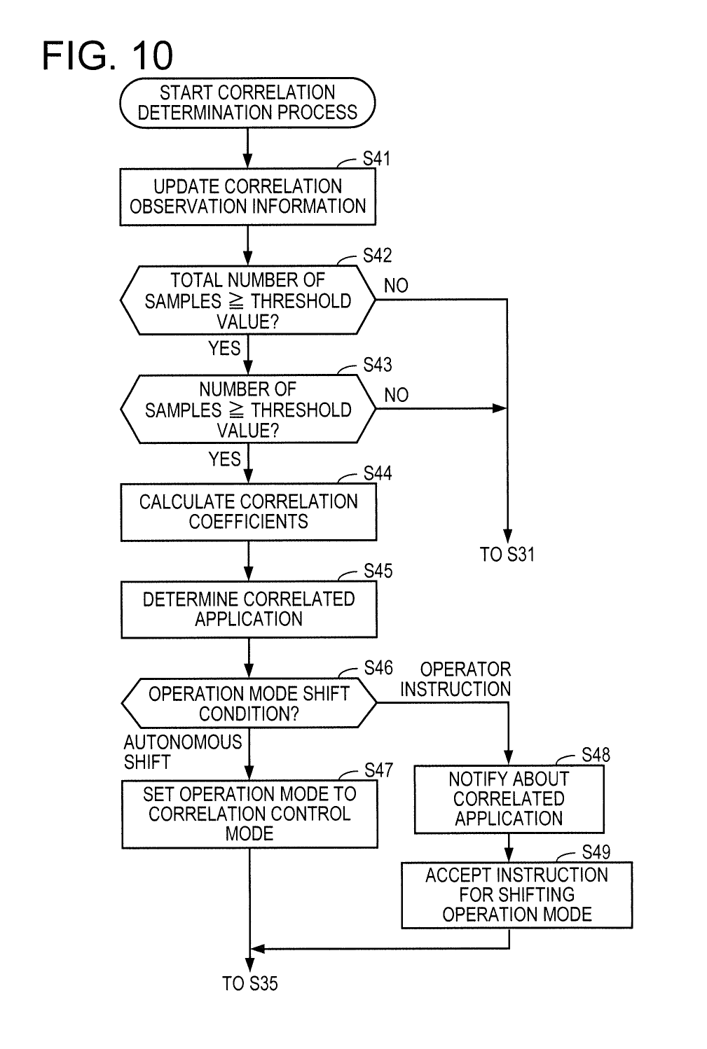

The correlated application is, for example, an application for which scale-out is executed within a predetermined time after scale-out is executed for another application in which an event of a load increase has occurred. The correlated application is, for example, an application for which scale-in is executed within a predetermined time after scale-in is executed for another application in which an event of a load decrease has occurred. Details of a process of determining the correlated application will be described later with reference to FIG. 10.

Here, it is assumed that the correlated application with respect to the application A is an application B.

(S19) The virtual resource management server 100 determines whether to perform a control of a resource pool capacity of the correlated application. The resource pool capacity is a maximum amount of resources that may be held by a resource pool.

For example, in response to the execution of the scale-out for the application A in which the event has occurred, the virtual resource management server 100 determines to perform a control to increase the resource pool capacity corresponding to the application B as the correlated application.

(S20) The virtual resource management server 100 transmits an instruction of increasing the resource pool capacity of the application B to the virtual infrastructure management server 180 and the application management server 190.

The virtual infrastructure management server 180 performs a control to increase the upper limit of the resource pool capacity of CPUs, memories, virtual machines, or the like to be allocated to the resource pool of the application B. The application management server 190 performs a control to increase the number (the resource amount) of virtual machines and applications B allocated to the resource pool of the application B.

(S21) The general-purpose server 201 increases the resource pool capacity and the resource amount of the application B resource pool 370 under the control of the virtual infrastructure management server 180 and the application management server 190.

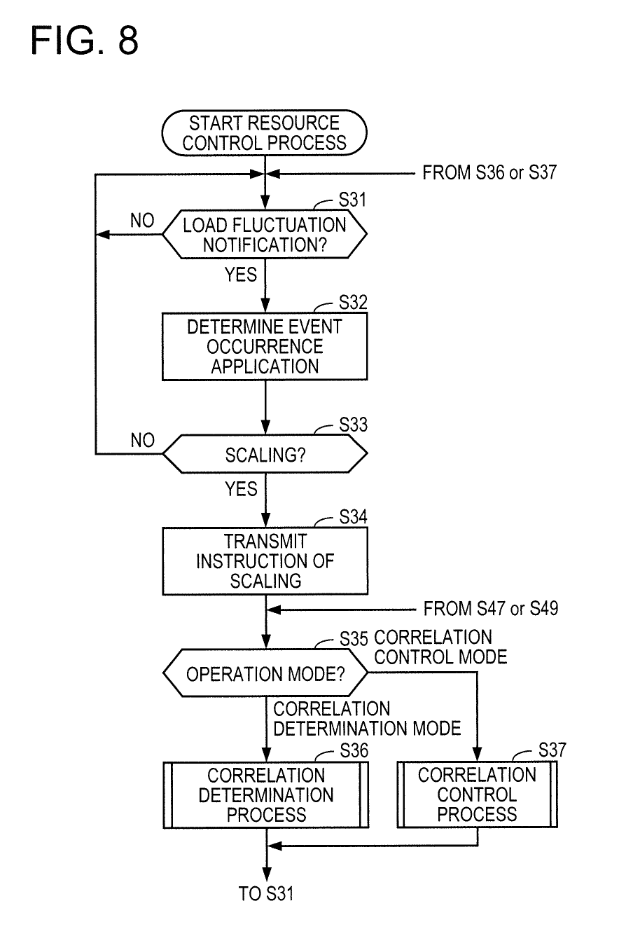

In the above-described processing sequence, an example in which an event of a load increase has occurred has been described, but the processing sequence may also be applied to the case where an event of a load decrease has occurred. When the event of the load decrease has occurred, the virtual resource management server 100 gives an instruction for the execution of scale-in in S15, and the general-purpose server 200 executes the scale-in. The virtual resource management server 100 gives an instruction for the reduction of the resource pool capacity of the resource pool in S20, and the general-purpose server 201 reduces the resource pool capacity. Details of a process of the virtual resource management server 100 will be described later with reference to FIGS. 8, 10, 14, and 17.

As described above, the virtual resource management server 100 increases/decreases the capacity of the resource pool of the correlated application in response to the scaling for the event-occurred application. The virtual resource management server 100 may increase the resource pool capacity and the resource amount before detecting a load increase of the correlated application so that the performance of an application to be provided to a user is not impaired. The virtual resource management server 100 may decrease the resource amount within the resource pool before detecting a load decrease of the correlated application so that resources are released quickly.

Next, a resource control process according to the second embodiment will be described with reference to FIG. 8. FIG. 8 is a flowchart illustrating a flow of the resource control process according to the second embodiment.

In the resource control process, the virtual resource management server 100 determines whether to execute scaling, and gives an instruction for determination of a correlated application and an instruction for control of the resource pool of the correlated application.

Upon receiving a notification that the load of an application has been fluctuated, the controller (the processor 101) of the virtual resource management server 100 performs the resource control process.

(S31) The controller determines whether a load fluctuation notification has been received from the virtual infrastructure management server 180 or the application management server 190. When it is determined that the load fluctuation notification has been received, the controller proceeds to S32, and when it is determined that the load fluctuation notification has not been received, the controller proceeds to S31.

The load fluctuation notification is information used for notifying about the fluctuation of the load of the application. The load fluctuation notification includes an application ID for identifying the application in which a load has increased or decreased, and a load observation value. The load observation value includes at least one of values of a CPU usage rate, a memory usage rate, and a throughput.

(S32) The controller determines the application in which the load fluctuation has occurred as an event-occurred application.

(S33) The controller determines whether to execute scaling. Specifically, the controller determines whether to execute the scaling by comparing the load observation value of the event-occurred application to an upper-limit load value and a lower-limit load value defined by the operation rule included in the application management information 610. When any one of the load observation values exceeds the upper-limit load value, the controller determines to execute scale-out. When any one of the load observation values is lower than the lower-limit load value, the controller determines to execute scale-in. When all of the load observation values are values between the upper-limit load value and the lower-limit load value, the controller determines not to execute the scaling. Upon determining to execute the scaling, the controller proceeds to S34. Upon determining not to execute the scaling, the controller proceeds to S31.

(S34) The controller transmits an instruction of scaling for the event-occurred application to the virtual infrastructure management server 180 and the application management server 190.

When the controller transmits an instruction of scale-out, the virtual infrastructure management server 180 performs a control to allocate resources such as a CPU or a memory to virtual machines. The application management server 190 performs a control to implement the added virtual machine and execute the event-occurred application. In this manner, the controller increases the number of virtual machines for executing the event-occurred application in the resource execution area 310.

When the controller transmits an instruction of scale-in, the application management server 190 performs a control to stop the virtual machine and the event-occurred application which are not executing processing for the user. The virtual infrastructure management server 180 releases resources such as a CPU or a memory allocated to the virtual machines. In this manner, the controller reduces the number of virtual machines for executing the event-occurred application in the resource execution area 310.

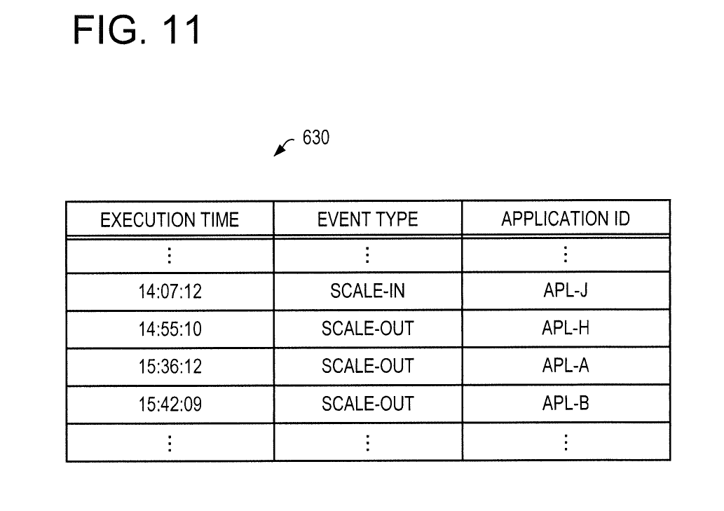

The controller records the history of scaling execution as an event log. The event to be recorded in the event log is scale-in or scale-out. The event log will be described later with reference to FIG. 11.

(S35) The controller reads operation mode management information from a storage unit, and determines an operation mode of a scaling group to which the event-occurred application belongs. The scaling group is identified by a scaling group ID included in the application management information 610. When it is determined that the operation mode is “correlation determination mode”, the controller proceeds to S36. When it is determined that the operation mode is “correlation control mode”, the controller proceeds to S37.

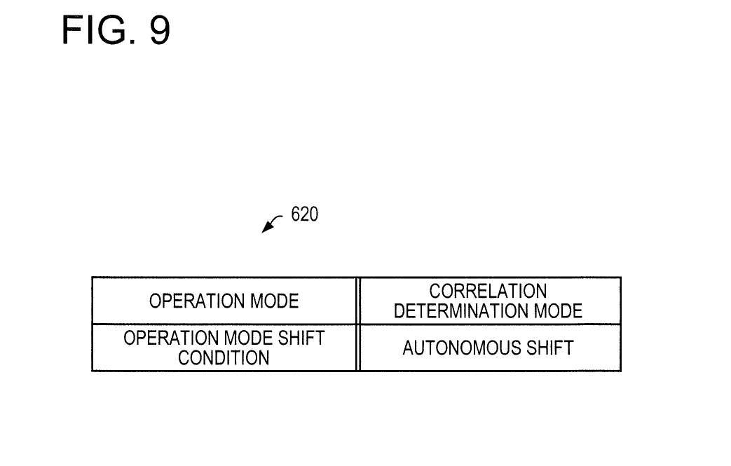

Here, the operation mode management information according to the second embodiment will be described with reference to FIG. 9. FIG. 9 is a diagram illustrating an example of the operation mode management information according to the second embodiment.

Operation mode management information 620 is used for managing an operation mode of each scaling group. The operation mode management information 620 is stored in a storage unit such as the HDD 103 of the virtual resource management server 100. The operation mode management information 620 includes items of an operation mode and an operation mode shift condition.

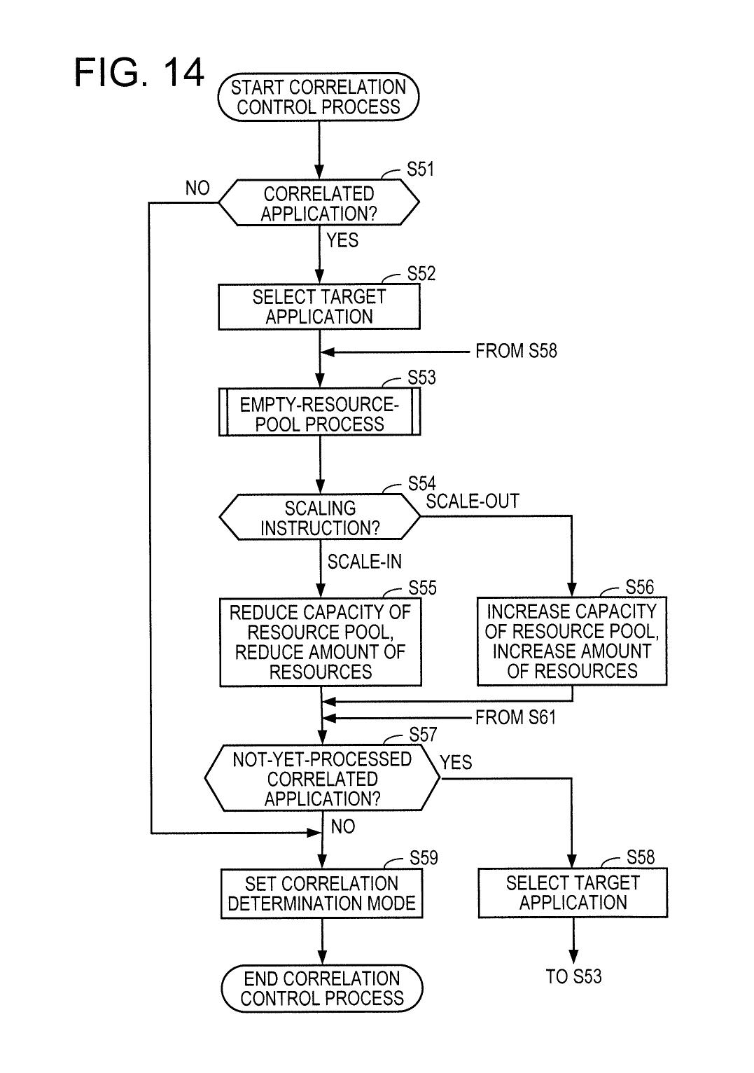

The operation mode is information used for determining a process performed by the virtual resource management server 100. In the operation mode, a value indicating either a correlation determination mode or a correlation control mode is set. When the correlation determination mode is set in the operation mode, the virtual resource management server 100 performs a correlation determination process. When the correlation control mode is set in the operation mode, the virtual resource management server 100 performs a correlation control process. The processing of setting the operation mode will be described later with reference to FIGS. 10 and 14. The initial value of the operation mode is set as a correlation determination mode by an operator.

The operation mode shift condition is information on a condition defined for the case where the operation mode is set from a current operation mode to another operation mode. In the operation mode shift condition, a value indicating either an autonomous shift or an operator instruction is set. When the autonomous shift is set in the operation mode shift condition, the virtual resource management server 100 sets the operation mode as the correlation control mode upon ending the correlation determination process, and sets the operation mode as the correlation determination mode upon ending the correlation control process. When the operator instruction is set in the operation mode shift condition, the virtual resource management server 100 sets the operation mode in accordance with an instruction received from the operator of the management system 400.

Return to the description of the flowchart of the resource control process again.

(S36) The controller performs the correlation determination process. The correlation determination process is a process of determining a correlated application. The correlation determination process will be described later with reference to FIG. 10.

(S37) The controller performs the correlation control process. The correlation control process is a process of performing a capacity control of the resource pool of the correlated application. The correlation control process will be described later with reference to FIG. 14.

Next, the correlation determination process according to the second embodiment will be described with reference to FIG. 10. FIG. 10 is a flowchart illustrating a flow of the correlation determination process according to the second embodiment.

The correlation determination process is a process of determining a correlated application. The correlation determination process is performed by the controller (the processor 101) of the virtual resource management server 100 in S36 of the resource control process.

(S41) The controller updates correlation observation information on the basis of the event log. That is, the controller extracts combinations of applications for which the same type of events have been performed during a determination time interval from data recorded in the event log, and reflects the combination on the correlation observation information.

Here, the event log according to the second embodiment will be described with reference to FIG. 11. FIG. 11 is a diagram illustrating an example of the event log according to the second embodiment.

An event log 630 is history information in which the history of scaling executed by the virtual resource management server 100 is recorded. The event log 630 is information stored in a storage unit such as the HDD 103 of the virtual resource management server 100. Each record of the event log 630 includes items of an execution time, an event type, and an application ID. The execution time is a time at which scale-in or scale-out is executed by the virtual resource management server 100. The event type indicates either scale-in or scale-out. The application ID is information used for identifying an application for which scale-in or scale-out is executed.

Next, the correlation observation information according to the second embodiment will be described with reference to FIG. 12. FIG. 12 is a diagram illustrating an example of the correlation observation information according to the second embodiment. Combinations of applications for which the same type of events have been performed during a determination time interval are extracted from the event log 630, and the combinations are reflected on correlation observation information 640. The correlation observation information 640 is used for determining the correlated application. Each record of the correlation observation information 640 includes items of an application ID, the number of observations of a successive application, and the number of samples. The correlation observation information 640 also includes an item of the total number of samples. The application ID is information used for identifying an application. The number of observations of a successive application is the number of times an event is performed for each application during a determination time interval since the same event is performed for the application identified by the application ID. The number of samples is the total number of the values registered in the number of observations of a successive application. The total number of samples is the total of the number of samples for all the records. A cover range of the correlation observation information illustrated in FIG. 12, that is, a sample population may be any one of an entire information processing system 500, each user, and each service ID.

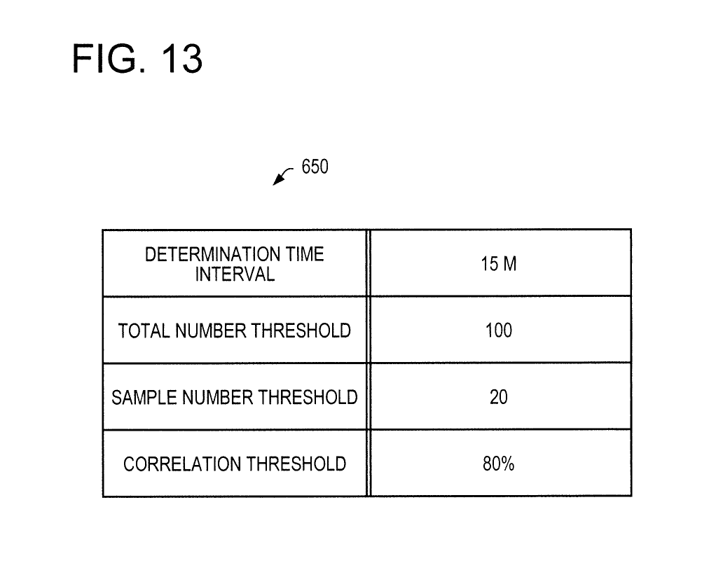

Next, correlation determination information according to the second embodiment will be described with reference to FIG. 13. FIG. 13 is a diagram illustrating an example of the correlation determination information according to the second embodiment. Correlation determination information 650 is used for extracting data from the event log, and determining a correlated application from the correlation observation information 640. The correlation determination information 650 is stored in a storage unit such as the HDD 103 of the virtual resource management server 100. The correlation determination information 650 includes items of a determination time interval, a total number threshold, a sample number threshold, and a correlation threshold. The determination time interval is a time used for extracting combinations of applications, for which the same type of events have been performed, from the event log 630. The total number threshold is a threshold value of the total number of samples. The sample number threshold is a threshold value of the number of samples. The correlation threshold is a threshold value of a correlation coefficient. The correlation coefficient is a value obtained by dividing each number of observations of a successive application by the number of samples.

Return to the description of the flowchart of the correlation determination process again.

Here, descriptions will be made on a process of extracting combinations of applications, for which the same type of events have been performed during a determination time interval, from data recorded in the event log by the controller, and reflecting the combinations on the correlation observation information 640.

The controller extracts, from the event log 630, data of events in which scale-in is executed for a certain application and within a determination time interval thereafter, scale-in is executed for another application. The controller extracts, from the event log 630, data of events in which scale-out is executed for a certain application and within a determination time interval thereafter, scale-out is executed for another application.

For example, descriptions will be made with reference to data of the event log 630. The controller reads data in which scale-out is executed for APL-A at 15:36:12. The controller reads data in which scale-out is executed for APL-B at 15:42:09 within a determination time interval (15 min) from the time when scale-out is executed for APL-A. The controller extracts the data in which scale-out is executed for APL-A at 15:36:12 and the data in which scale-out is executed for APL-B at 15:42:09 as related information from the event log 630. Among the extracted related information, it is assumed that “APL-A” at an earlier execution time is the application ID in the correlation observation information 640, and “APL-B” at a later execution time is the application ID of a successive application in the correlation observation information 640. The value of an entry corresponding to “APL-B” in the item of the number of observations of a successive application in a record having the application ID “APL-A” is incremented by “1” so that the relation is reflected on the correlation observation information 640.

(S42) The controller determines whether the total number of samples is equal to or larger than the total number threshold. When it is determined that the total number of samples is equal to or larger than the total number threshold, the controller proceeds to S43, and when it is determined that the total number of samples is less than the total number threshold, the controller proceeds to S31.

(S43) The controller determines, for the event-occurred application, whether the number of samples is equal to or larger than the sample number threshold. When it is determined that the number of samples is equal to or larger than the sample number threshold, the controller proceeds to S44, and when it is determined that the number of samples is less than the sample number threshold, the controller proceeds to S31.

(S44) The controller calculates correlation coefficients for the event-occurred application. That is, the controller calculates the correlation coefficient of the number of observations for each successive application of the event-occurred application.

Here, descriptions will be made on calculation of the correlation coefficients when the event-occurred application is “APL-A”, with reference to data of the correlation observation information 640.

The value of the entry corresponding to “APL-B” in the number of observations of a successive application is “17” in the record having the application ID “APL-A”. The number of samples is “20” in the record having the application ID “APL-A”. Thus, the correlation coefficient between the application ID “APL-A” and the successive application “APL-B” becomes 85% as the percentage of the quotient ( 17/20=0.85) where the numerator is 17, and the denominator is 20. Similarly, the correlation coefficient between the application ID “APL-A” and the successive application “APL-C” becomes 5% as the percentage of the quotient ( 1/20=0.05) where the numerator is 1, and the denominator is 20.

(S45) The controller determines an application with a correlation coefficient equal to or larger than the correlation threshold as the correlated application of the event-occurred application.

For example, the case where the event-occurred application is “APL-A” will be described. Here, the correlation threshold is 80% according to the correlation determination information 650. Since the correlation coefficient between the application ID “APL-A” and the successive application “APL-B” is 85% and is equal to or larger than the correlation threshold 80%, the controller determines “APL-B” as the correlated application.

(S46) The controller determines whether the operation mode shift condition is autonomous shift. When it is determined that the operation mode shift condition is “autonomous shift”, the controller proceeds to S47, and when it is determined that the operation mode shift condition is “operator instruction” (not “autonomous shift”), the controller proceeds to S48.

(S47) The controller sets the operation mode to the correlation control mode, and proceeds to S35.

(S48) The controller notifies the operator of the application ID of the correlated application and displays, on the display 111, a prompt for accepting an instruction of shifting the operation mode.

The controller may notify the operator of the application ID of the correlated application by displaying the ID on the display 111, sending the ID via e-mail, or using other methods.

(S49) The controller accepts an instruction to set the operation mode to the correlation control mode, and proceeds to S35.

The above-described method is exemplary only, and the correlated application may be determined by other methods. For example, the correlated application may be determined by extracting a combination of data in which different types of events are performed during a determination time interval from data recorded in the event log 630. The correlation may be determined by other methods.

Next, the correlation control process according to the second embodiment will be described with reference to FIG. 14. FIG. 14 is a flowchart illustrating a flow of the correlation control process according to the second embodiment.

The correlation control process is a process of executing the capacity control of the resource pool of the correlated application. The correlation control process is performed by the controller (the processor 101) of the virtual resource management server 100 in S37 of the resource control process.

(S51) The controller determines whether correlated applications are present with respect to the event-occurred application. When it is determined that correlated applications are present, the controller proceeds to S52. When it is determined that no correlated application is present, the controller proceeds to S59.

(S52) The controller selects one of correlated applications as a target application. For example, when there are a plurality of correlated applications, the controller selects one application in descending order of the correlation coefficient, as a target application.

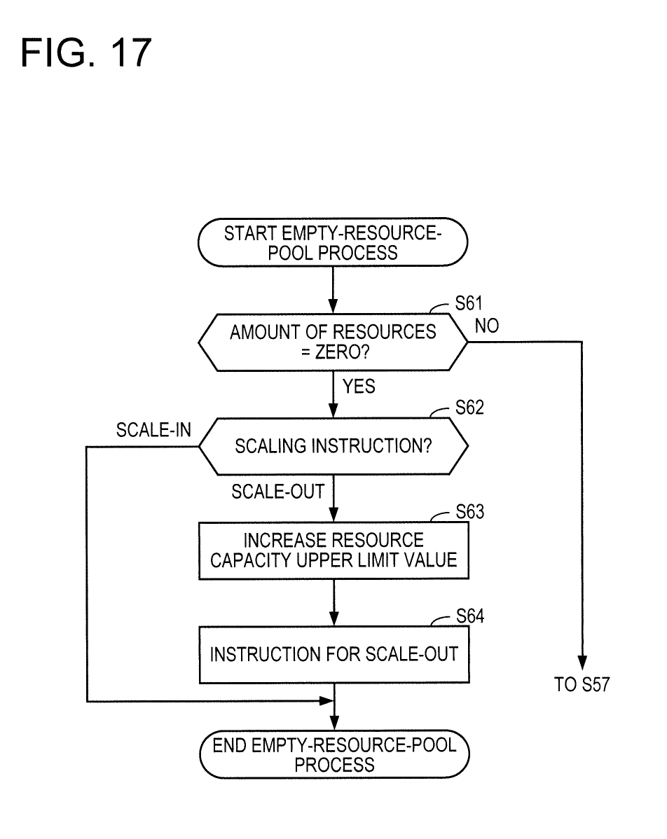

(S53) The controller performs an empty-resource-pool process. The empty-resource-pool process is a process of determining whether the resource pool of the target application includes no resources (zero), and giving an instruction for the control of the resource pool. The empty-resource-pool process will be described later with reference to FIG. 17.

(S54) The controller determines whether the instruction of scaling in S34 is scale-in or scale-out. When it is determined that the instruction of scaling is scale-in, the controller proceeds to S55, and when it is determined that the instruction of scaling is scale-out, the controller proceeds to S56.

(S55) The controller reduces the capacity of the resource pool of the target application, and reduces the amount of resources included in the resource pool.

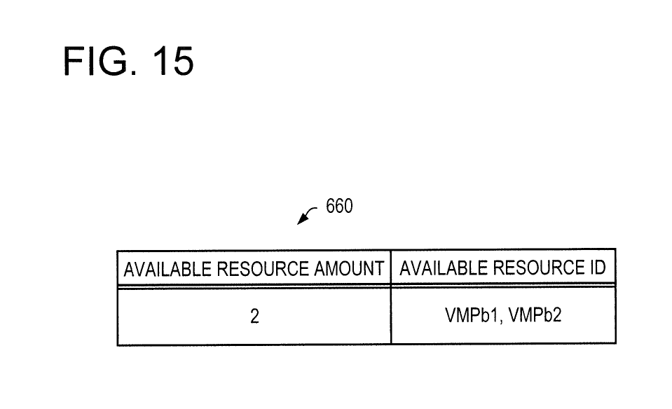

Here, resource pool state information according to the second embodiment will be described with reference to FIG. 15. FIG. 15 is a diagram illustrating an example of the resource pool state information according to the second embodiment.

Resource pool state information 660 indicates the state of resources included in a resource pool. The resource pool state information 660 exists corresponding to a resource pool for each application, that is, information that exists for each scaling group ID. The resource pool state information 660 is stored in a storage unit such as the HDD 103 of the virtual resource management server 100.

The resource pool state information 660 includes items of an available resource amount, and available resource IDs. The available resource amount is an amount of resources included in the resource pool, for example, the number of virtual machines each provided with an application in the stand-by state. The available resource IDs are IDs used for identifying resources included in the resource pool. The available resource IDs may include IDs of virtual machines included in the resource pool, IDs of applications, or the like.

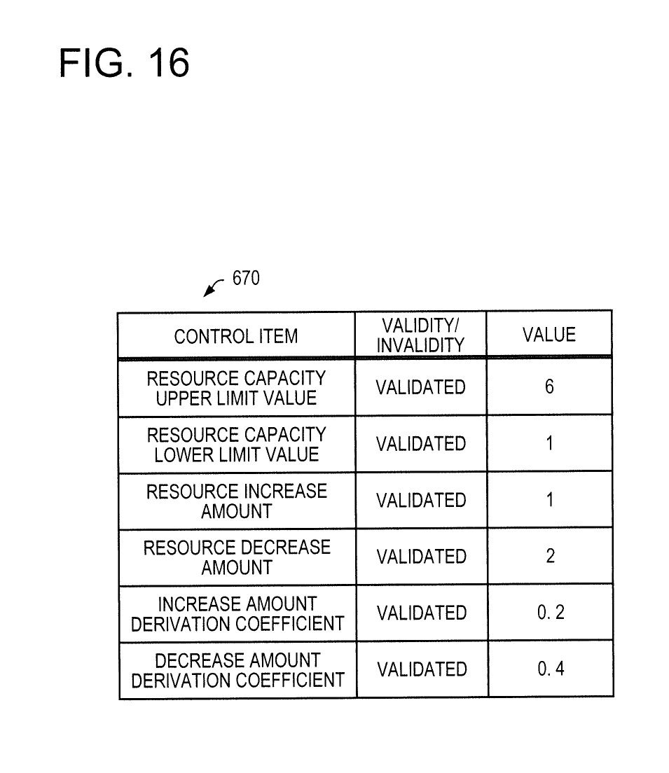

Next, resource pool control information according to the second embodiment will be described with reference to FIG. 16. FIG. 16 is a diagram illustrating an example of the resource pool control information according to the second embodiment.

Resource pool control information 670 is used for controlling a resource pool. The resource pool control information 670 exists corresponding to a resource pool for each application, that is, exists for each scaling group ID. The resource pool control information 670 is stored in a storage unit such as the HDD 103 of the virtual resource management server 100.

Each record of the resource pool control information 670 includes items of a control item, validity/invalidity, and a value. The control item is one of a resource capacity upper limit value, a resource capacity lower limit value, a resource increase amount, a resource decrease amount, an increase amount derivation coefficient, and a decrease amount derivation coefficient. The resource capacity upper limit value is a value indicating an upper limit of the capacity of the resource pool. The resource capacity lower limit value is a value indicating a lower limit of the capacity of the resource pool. The resource increase amount is a unit amount of resources increased when the resource amount included in the resource pool is increased. The amount of resources includes the allocation amount of computer resources such as memories or CPUs, the number of virtual machines, or the like. The resource decrease amount is a unit amount of resources decreased when the resource amount included in the resource pool is decreased. The increase amount derivation coefficient is a value for changing the resource increase amount. The decrease amount derivation coefficient is a value for changing the resource decrease amount. The initial value of each control item may be set in advance by the operator.

The item of validity/invalidity in the resource pool control information 670 indicates that the relevant control item is validated or invalidated. When the control item is validated, the capacity control of resources of the resource pool is performed depending on the value set in the control item. When the control item is invalidated, the value of each control item is set by input of the operator.

Return to the description of the flowchart of the correlation control process again.

Here, descriptions will be made on a process of decreasing the capacity of the resource pool by the controller. The controller acquires the resource capacity upper limit value and the resource decrease amount from the resource pool control information 670, and sets a value obtained by subtracting the resource decrease amount from the resource capacity upper limit value, as the resource capacity upper limit value. When the value obtained by subtracting the resource decrease amount from the resource capacity upper limit value is equal to or less than the resource capacity lower limit value, the controller does not need to perform this process.

Next, descriptions will be made on a process of decreasing the amount of resources included in the resource pool by the controller. The controller reads the available resource amount from the resource pool state information 660, and reads the resource capacity lower limit value and the decrease amount derivation coefficient from the resource pool control information 670. When the available resource amount exceeds the resource capacity lower limit value, the controller decreases resources in the resource pool by the resource decrease amount. The controller sets a value obtained by adding the decrease amount derivation coefficient to the value of the resource decrease amount, as the resource decrease amount.

When the value obtained by subtracting the resource decrease amount from the available resource amount is equal to or less than the resource capacity lower limit value, the controller does not need to perform this process.

(S56) The controller increases the capacity of the resource pool of the target application, and increases the amount of resources included in the resource pool.

Here, descriptions will be made on a process of increasing the capacity of the resource pool by the controller. The controller acquires the resource capacity upper limit value and the resource increase amount from the resource pool control information 670, and sets a value obtained by adding the resource increase amount to the resource capacity upper limit value, as the resource capacity upper limit value.

Next, descriptions will be made on a process of increasing the amount of resources included in the resource pool by the controller. The controller reads the available resource amount from the resource pool state information 660, and reads the resource capacity upper limit value and the increase amount derivation coefficient from the resource pool control information 670. When the available resource amount does not exceed the resource capacity upper limit value, the controller increases the amount of resources by generating resources in the resource pool by the resource increase amount. The controller sets a value obtained by adding the increase amount derivation coefficient to the value of the resource increase amount, as the resource increase amount.

When the value obtained by adding the resource increase amount to the available resource amount exceeds the resource capacity upper limit value, the controller does not need to execute S56.

(S57) The controller determines whether correlated applications not yet processed in S53 to S57 are present. When it is determined that not-yet-processed correlated applications are present, the controller proceeds to S58, and when it is determined that no not-yet-processed correlated application is present, the controller proceeds to S59.

(S58) The controller selects one of the correlated applications not yet processed in S53 to S57 as a target application, and proceeds to S53.

(S59) The controller sets an operation mode to a correlation determination mode, and ends the correlation control process.

Next, descriptions will be made on the empty-resource-pool process according to the second embodiment with reference to FIG. 17. FIG. 17 is a flowchart illustrating a flow of the empty-resource-pool process according to the second embodiment.

The empty-resource-pool process is a process of determining whether the resource pool of the target application includes no resources (zero), and giving an instruction for the control of the resource pool. The empty-resource-pool process is performed by the controller (the processor 101) of the virtual resource management server 100 in S53 of the correlation control process.

(S61) The controller determines whether the amount of resources of the resource pool corresponding to the target application is zero. When the amount of resources is zero, the controller proceeds to S62, and when the amount of resources is not zero, the controller proceeds to S57.

When the amount of resources of the resource pool is zero, the resource pool includes no resources.

(S62) The controller determines whether the instruction of scaling in S34 is scale-in or scale-out. When it is determined that the instruction of scaling is scale-out, the controller proceeds to S63. When it is determined that the instruction of scaling is scale-in, the controller ends the empty-resource-pool process.

(S63) The controller increases the resource capacity upper limit value. For example, the controller sets a value obtained by adding the resource increase amount to the resource capacity upper limit value, to the resource capacity upper limit value.

(S64) The controller instructs the virtual infrastructure management server 180 and the application management server 190 to execute scale-out for the target application. For example, the controller generates resources of the resource increase amount, and transmits an instruction to incorporate the generated resources into the resource execution area 310 of the target application. That is, the controller directly increases the resources of the resource execution area 310 not through the resource pool 350 (without increasing the resources of the resource pool 350).

The above-described empty-resource-pool process may be applied to not only the case where the resource pool includes no resources, but also the case where the amount of resources is less than a predetermined amount or the case where the resources to be allocated to the application are insufficient.

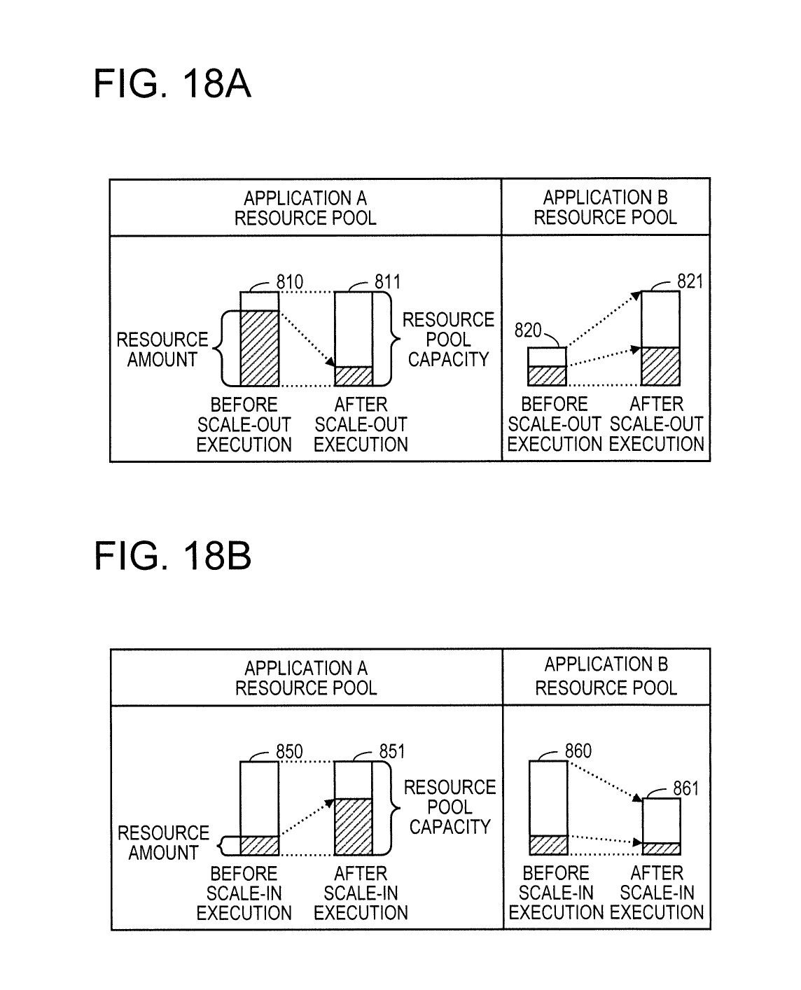

Next, descriptions will be made on a control of a resource pool before and after execution of the scale-out according to the second embodiment, and a control of a resource pool before and after execution of the scale-in according to the second embodiment with reference to FIGS. 18A and 18B. FIG. 18A is a diagram illustrating the control of the resource pool before and after execution of the scale-out according to the second embodiment. FIG. 18B is a diagram illustrating the control of the resource pool before and after execution of the scale-in according to the second embodiment.

In the description of FIGS. 18A and 18B, it is assumed that the application A resource pool 360 is a resource pool corresponding to an event-occurred application, and the application B resource pool 370 is a resource pool corresponding to a correlated application.

FIG. 18A is a diagram illustrating a control of a resource pool capacity and a resource amount before and after execution of the scale-out. In the application A resource pool 360, since resource allocation to the application A execution area 320 occurs due to the scale-out, the resource amount decreases (810, 811). In the application B resource pool 370, since resource control is performed by the virtual resource management server 100, the capacity of the resource pool is increased and also the resource amount is increased after the scale-out occurs in the application A (820, 821). In this manner, when the scale-out is executed for the application A, both the resource pool capacity and the resource amount of the application B resource pool 370 increase.

FIG. 18B is a diagram illustrating a control of a resource pool capacity and a resource amount before and after execution of the scale-in. In the application A resource pool 360, since resources incorporated into the application A execution area 320 are canceled and returned to the application A resource pool 360 due to the scale-in, the resource amount increases (850, 851). In the application B resource pool 370, resource control is performed by the virtual resource management server 100, and both the resource pool capacity and the resource amount decrease (860, 861).

As described above, the virtual resource management server 100 may determine a correlated application which is correlated with an application in which a load fluctuation has occurred, and perform a capacity control of resources of a resource pool of the correlated application before executing scaling for the correlated application. Accordingly, the virtual resource management server 100 may reduce the exhaustion of resources or excessive allocation of resources for the correlated application.

In the cloud system 300, a required resource capacity, a unit of resource consumption, and a pattern of resource consumption may vary for each application. Thus, it is inevitable to set an expected margin for each application, and excessive allocation of resources may occur in some cases. When resources are excessively allocated to a certain service, resources available for other services that use the cloud system 300 in common are decreased. Thus, separate resource allocation to other services may be required, and there is a concern that a cost of management or operation is increased. In the cloud system 300, when one service is provided by a plurality of applications, as resources of a resource pool corresponding to any one of the applications are exhausted, an influence such as a reduction of the processing capacity of the service as a whole may occur.

The virtual resource management server 100 performs a control of a resource pool before executing scaling for the correlated application, thereby reducing excessive allocation of resources or degradation of a processing capacity of the service as a whole.

When the cloud system 300 has a complicated configuration in which a plurality of applications are multi-leveled or branch-connected, it is difficult for the operator to grasp, in advance, a load fluctuation of the plurality of applications or a required resource amount, and thus it has taken a lot of labor to perform the control.

The virtual resource management server 100 may determine the correlated application and perform a control of the resource amount, thereby reducing the labor of the operator performing the control of the resource amount of the plurality of applications.

In this manner, the virtual resource management server 100 may control the capacity of the resource pool of a certain application in response to scaling for another application, thereby avoiding the exhaustion of resources while attempting to reduce spare resources.

The above-described function may be implemented by a computer. In this case, programs describing the processing contents of functions that the control device 50, the virtual resource management server 100, the virtual infrastructure management server 180, the application management server 190, and the general-purpose servers 200, 201, and 202 may have is provided, respectively. When the program is executed by the computer, the function is implemented on the computer. The program describing the processing contents may be recorded in a computer-readable recording medium. As the computer-readable recording medium, a magnetic storage device, an optical disk, a magneto-optical recording medium, a semiconductor memory, and the like may be exemplified. As the magnetic storage device, an HDD, a flexible disc (FD), a magnetic tape, and the like may be exemplified. As the optical disk, a digital versatile disc (DVD), a DVD-RAM, a compact disc read-only memory/ReWritable (CD-ROM/RW), and the like may be exemplified. As the magneto-optical recording medium, a magnetooptic disc (MO) and the like may be exemplified.

When the program is distributed, for example, a portable recording medium such as a DVD or a CD-ROM in which the program is recorded is sold. The program may be stored in a storage device of a server computer, and then may be transmitted to another computer from the server computer via a network.

The computer for executing a program stores, for example, a program recorded in a portable recording medium or a program transmitted from a server computer, in its own storage device. Then, the computer reads the program from its own storage device, and performs processes according to the program. The computer may directly read the program from the portable recording medium, and perform the processes according to the program. The computer may sequentially perform the processes according to a received program which is successively transmitted from the server computer coupled thereto via a network.

At least a part of the above-described functions may be implemented by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device, comprising:
a memory; and
a processor coupled to the memory and the processor configured to:
determine whether a correlation is present between increase or decrease of a first amount of first virtual machines for performing a first function and increase or decrease of a second amount of second virtual machines for performing a second function; and
determine a capacity of spare virtual machines in response to increase or decrease of the first amount upon determining that the correlation is present, the spare virtual machines being prepared for performing the second function, the capacity being a maximum amount.

2. The control device according to claim 1, wherein
the processor is configured to:
store history information in the memory, the history information indicating a time at which the first amount is increased or decreased or a time at which the second amount is increased or decreased;
extract related information from the history information, the related information indicating that increase or decrease of the first amount and increase or decrease of the second amount are performed within a predetermined time interval; and
determine that the correlation is present on basis of the extracted related information.

3. The control device according to claim 1, wherein
the processor is configured to:
perform control to increase or decrease the capacity of the spare virtual machines on basis of increase or decrease of the first amount; and
perform control to increase or decrease a third amount of the spare virtual machines on basis of increase or decrease of the first amount.

4. The control device according to claim 1, wherein
the processor is configured to:
perform control to increase the capacity of the spare virtual machines when the first amount is increased; and
perform control to increase a third amount of the spare virtual machines when the first amount is increased.

5. The control device according to claim 1, wherein
the processor is configured to:
perform control to decrease the capacity of the spare virtual machines when the first amount is decreased; and
perform control to decrease a third amount of the spare virtual machines when the first amount is decreased.

6. The control device according to claim 1, wherein
the processor is configured to:
determine a first difference on basis of the capacity of the spare virtual machines, the first difference being an amount by which the capacity of the spare virtual machines is increased or decreased; and
determine a second difference on basis of a third amount of the spare virtual machines, the second difference being an amount by which the third amount is increased or decreased.

7. The control device according to claim 1, wherein
the processor is configured to:
increase the second amount without increasing a third amount of the spare virtual machines when the first amount is increased and when the third amount is less than a predetermined amount.

8. A control method, comprising:
determining, by a computer, whether a correlation is present between increase or decrease of a first amount of first virtual machines for performing a first function and increase or decrease of a second amount of second virtual machines for performing a second function; and
determining a capacity of spare virtual machines in response to increase or decrease of the first amount upon determining that the correlation is present, the spare virtual machines being prepared for performing the second function, the capacity being a maximum amount.

9. A non-transitory computer-readable recording medium having stored therein a program that causes a computer to execute a process, the process comprising:
determining whether a correlation is present between increase or decrease of a first amount of first virtual machines for performing a first function and increase or decrease of a second amount of second virtual machines for performing a second function; and
determining a capacity of spare virtual machines in response to increase or decrease of the first amount upon determining that the correlation is present, the spare virtual machines being prepared for performing the second function, the capacity being a maximum amount.
